(19) United States
(12) Patent Application Publication
(10) Pub. No.: US 2019/0304224 A1
(43) Pub. Date: Oct. 3, 2019

(54) Statistics Based Systems And Methods For Activating Vehicle Functions

(71) Applicants: DENSO International America, Inc., Southfield, MI (US); DENSO CORPORATION, Kariya-city (JP)

(72) Inventor: Kyle GOLSCH, Pontiac, MI (US)

(21) Appl. No.: 16/359,050

(22) Filed: Mar. 20, 2019

Related U.S. Application Data
(60) Provisional application No. 62/648,976, filed on Mar. 28, 2018.

(51) Int. Cl. G07C 9/00; H04W 76/14; H04W 88/16; H04W 4/40

(52) U.S. Cl. CPC G07C 9/00309; H04W 76/14; G07C 2209/63; H04W 4/40; G07C 2009/00507; H04W 88/16

(57) ABSTRACT

Systems and methods are provided and include a communication gateway of a control module. The communication gateway establishes a wireless communication connection with a user device. A plurality of sensors are configured to, in response to the user device being connected to the communication gateway, communicate signal information about the wireless communication connection to the control module. A reference data generator module determines a first probability value based on the signal information. The first probability value indicates a probability that a user of the user device will enter a vehicle. A passive entry/passive start (PEPS) system is configured to, in response to the first probability value being greater than at least one threshold probability, activate a vehicle function associated with the at least one threshold probability.

### CROSS-REFERENCE TO RELATED APPLICATION

This application claims the benefit of U.S. Provisional Application No. 62/648,976, filed on Mar. 28, 2018. The entire disclosure of the above application is incorporated herein by reference.

### FIELD

The present disclosure relates to systems and methods for activating vehicle functions based on the probability of a user of a user device entering a vehicle.

### BACKGROUND

This section provides background information related to the present disclosure which is not necessarily prior art.

Traditionally, a passive entry/passive start (PEPS) system, which is a vehicle system that includes a keyless entry system, allows anyone in possession of a key fob that has been previously paired with a vehicle's central PEPS electronic control unit (ECU) to access the vehicle by simply grabbing the door handle and to start the vehicle with a push of a button. In response to a button push, the central PEPS ECU authenticates the key fob to determine if the key fob is authorized to access the vehicle and uses the signal strength indicated by a plurality of vehicle antennas to estimate the location of the Key Fob. If the Key Fob can be authenticated and is located within an authorizing zone, the vehicle's function is made available to the user (i.e. doors are unlocked or vehicle is started).

Traditional PEPS systems use proprietary grade radio protocols using low frequency (LF) signals of approximately 125 kHz. Traditional PEPS systems are also hampered by the physics of the LF systems. LF was selected by early PEPS systems because the wave propagation allows for relatively accurate estimation of range and location by using signal strength within the typical target activation range of 2 meters. However, due to the extremely long wavelength of the LF signal compared to the size of a practical vehicle antenna and key fob receiver, it is difficult within reasonable power consumption and safe transmit power levels to reliably communicate with a key fob using LF beyond a few meters. Consequently, it is difficult to make any of the vehicle's functions available to the user when the key fob is located more than a few meters away from the vehicle.

Furthermore, it is desirable to allow users to use their smart devices, such as smartphones and other devices, such as wearable devices, as a vehicle key. In addition, long range distancing features is also becoming critical for convenience features like passive welcome lighting, distance bounding on remote parking applications, and so on. Such systems and advantages are not achievable with traditional PEPS systems because each vehicle manufacturers and PEPS system suppliers traditionally implement proprietary closed systems using radio frequencies that are not used by ubiquitous devices, such as smart phones.

### SUMMARY

This section provides a general summary of the disclosure, and is not a comprehensive disclosure of its full scope or all of its features.

The present disclosure provides a system that includes a communication gateway of a control module of a vehicle. The communication gateway is configured to establish a wireless communication connection with a user device, and the control module includes at least one processor that is configured to execute instructions stored in a nontransitory memory. The system includes a plurality of sensors that are configured to, in response to the user device being connected to the communication gateway, communicate signal information about the wireless communication connection to the control module. The system includes a reference data generator module that is implemented by the at least one processor of the control module, and the reference data generator module is configured to determine a first probability value based on the signal information. The first probability value indicates a probability that a user of the user device will enter the vehicle. The system includes a passive entry/passive start (PEPS) system that is configured to, in response to the first probability value being greater than at least one threshold probability, activate a vehicle function associated with the at least one threshold probability.

In some configurations, the reference data generator module is configured to determine the first probability value is greater than the at least one threshold probability based on a probability curve. The probability curve is generated by the reference data generator module and is based on at least one entry of a reference data store that is implemented by the nontransitory memory.

In some configurations, the reference data generator module is configured to generate a first entry of the at least one entry, and the first entry is based on the signal information and corresponds to the first probability value.

In some configurations, each of the at least one entry is associated with a measurement event and includes information indicating with whether the user of the user device enters the vehicle, signal information of the measurement event, and location data of the measurement event.

In some configurations, the probability curve is based on at least one dynamic probability value, and the at least one dynamic probability value indicates the probability that the user of the user device will enter the vehicle when the user of the user device is within a threshold distance of the vehicle.

In some configurations, the at least one dynamic probability value is configured to update in response to the reference data generator module generating a new entry of the at least one entry.

In some configurations, the probability curve is a continuous curve.

In some configurations, the vehicle function includes at least one of unlocking a door of the vehicle, unlocking a trunk of the vehicle, starting the vehicle, activating a heating system of the vehicle, activating an air conditioning system of the vehicle, and activating a lighting system of the vehicle.

In some configurations, the wireless communication connection is a Bluetooth low energy (BLE) communication connection.

In some configurations, the signal information further includes at least one of a signal strength, a time of arrival, a time difference of arrival, an angle of arrival, and a round trip time of flight of a two-way ranging communication signal between the set of the plurality of sensors and the user device.

Additionally, the present disclosure provides a method that comprises establishing, with a communication gateway of a control module in a vehicle, wireless communication connection with a user device. The control module includes at least one processor that is configured to execute instructions stored in a nontransitory memory. The method also includes communicating, in response to establishing the wireless communication connection, signal information about the wireless communication connection from a plurality of sensors to the control module. The method includes determining, using a reference data generator module that is implemented by the at least one processor of the control module, a first probability value based on the signal information. The first probability value indicates a probability that a user of the user device will enter the vehicle. The method also includes, in response to the first probability value being greater than at least one threshold probability, activating, using a passive entry/passive start (PEPS) system, a vehicle function associated with the at least one threshold probability.

In some configurations, determining the first probability value is greater than the at least one threshold probability is based on a probability curve, and the probability curve is generated by the reference data generator module and is based on at least one entry of a reference data store that is implemented by the nontransitory memory.

In some configurations, the method further comprises generating a first entry of the at least one entry, and the first entry is based on the signal information and corresponds to the first probability value.

In some configurations, each of the at least one entry is associated with a measurement event and includes information indicating with whether the user of the user device enters the vehicle, signal information of the measurement event, and location data of the measurement event.

In some configurations, the probability curve is based on at least one dynamic probability value, and the at least one dynamic probability value indicates the probability that the user of the user device will enter the vehicle when the user of the user device is within a threshold distance of the vehicle.

In some configurations, the method further comprises updating the at least one dynamic probability value in response to the reference data generator module generating a new entry of the at least one entry.

In some configurations, the probability curve is a continuous curve.

In some configurations, activating the vehicle function includes at least one of unlocking a door of the vehicle, unlocking a trunk of the vehicle, and starting the vehicle, activating a heating system of the vehicle, activating an air conditioning system of the vehicle, and activating a lighting system of the vehicle.

In some configurations, the wireless communication connection is a Bluetooth low energy (BLE) communication connection.

In some configurations, the signal information further includes at least one of a signal strength, a time of arrival, a time difference of arrival, an angle of arrival, and a round trip time of flight of a two-way ranging communication signal between the set of the plurality of sensors and the user device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a subject vehicle with a PEPS system according to the present disclosure.

FIG. 2 illustrates a block diagram for a PEPS system according to the present disclosure.

FIG. 3 illustrates a block diagram for a sensor of a PEPS system according to the present disclosure.

FIG. 4 illustrates a communication gateway of a PEPS system according to the present disclosure.

FIG. 5 illustrates a subject vehicle with a PEPS system according to the present disclosure.

FIG. 6A illustrates a reference database of the PEPS system according to the present disclosure.

FIG. 6B illustrates probability curves of the PEPS system according to the present disclosure.

FIG. 7 illustrates a flowchart of an example algorithm for generating a reference database according to the present disclosure.

FIG. 8 illustrates a flowchart of an example algorithm for determining the probability that a user of a user device will enter into a subject vehicle according to the present disclosure.

Corresponding reference numerals indicate corresponding parts throughout the several views of the drawings.

### DETAILED DESCRIPTION

Example embodiments will now be described more fully with reference to the accompanying drawings.

The present disclosure relates to systems, methods, and architecture to implement a localization system, such as a PEPS system, using a consumer grade wireless protocol, such as, for example, a consumer grade wireless protocol based on the standardized specification of the Bluetooth Consortium. Specifically, the present disclosure relates to a PEPS system using a Bluetooth Low Energy (BLE) communication protocol for communication between the vehicle and a BLE-enabled user device, such as a smartphone or a wearable device. Specifically, the PEPS system includes a sensor network that is configured to find existing connections between the user device and the vehicle and to measure the timing and signal characteristics of the communication between the user device and the vehicle. Further, the PEPS system also includes a central module that collects received signal strengths measured by the sensor network, and based on the received signal strengths, the central module may determine the displacement of the user device with respect to the vehicle. Alternatively, while the present disclosure describes establishing a wireless communication connection using Bluetooth or BLE, the systems and methods described herein could be used with other wireless communication protocols, such as Wi-Fi, Wi-Fi direct, ultra-wide band (UWB) communication, and/or impulse-radio (IR) UWB communication.

Further, the PEPS system may acquire multiple location measurements of the user device and store data corresponding to the multiple location measurements in a database. Using the multiple location measurements of the user device along with other variables associated with each of multiple location measurements, the PEPS system can generate reference data from which the PEPS system can predict user behavior associated with the user device, as described below in further detail. As an example, the PEPS system may determine the probability that the user will enter the vehicle based on a comparison of the reference data and at least one location measurement received by the sensor network. Subsequently, the PEPS system may make certain vehicle functions available to the user based on the determined probability, as described below in further detail.

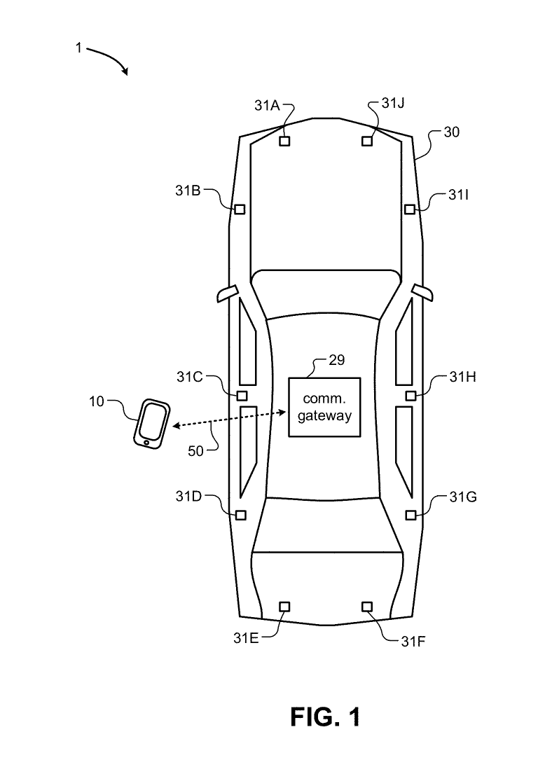

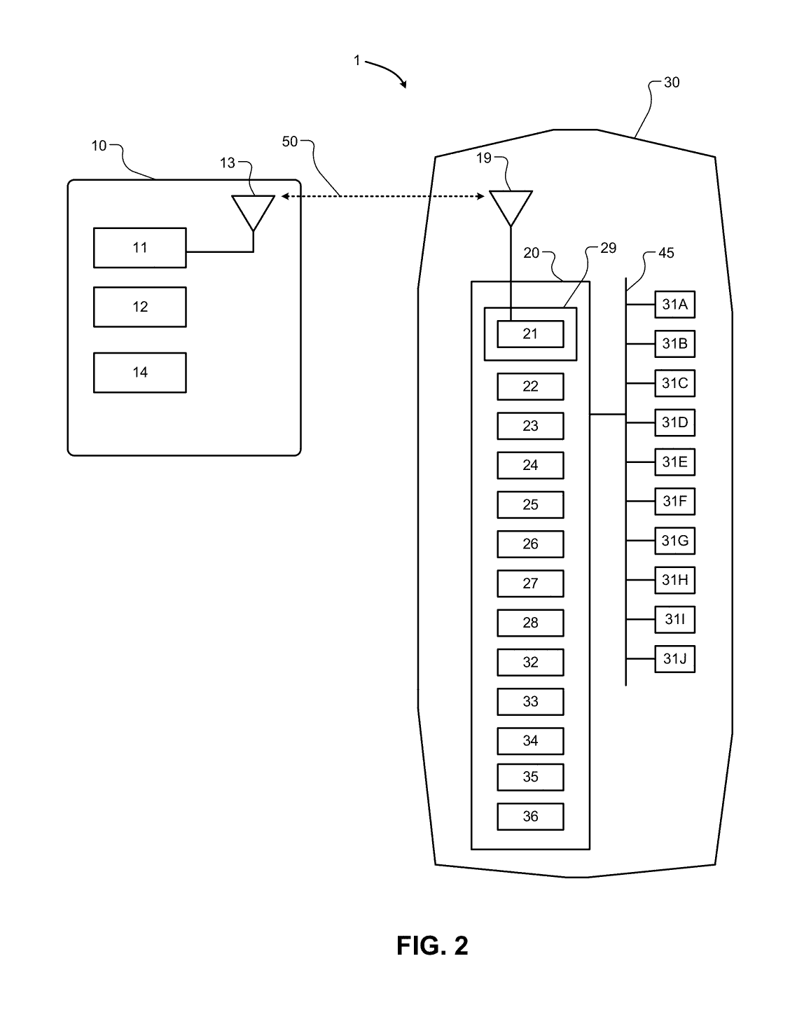

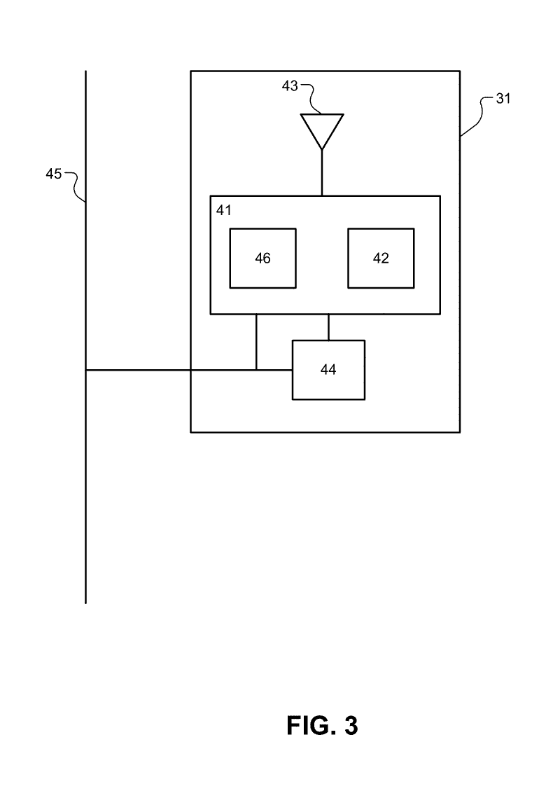

With reference to FIGS. 1 and 2, a PEPS system 1, which may also be referred to as a localization system, is provided within a vehicle 30 and includes a communication gateway 29 and a plurality of sensors 31A-31J, referred to collectively as sensors 31. The PEPS system 1 includes one or more control modules 20 that are distributed throughout the vehicle 30 and are able to communicate with each other through, for example, a vehicle interface 45. In addition, some of the modules may be integrated into a single electronic control unit (ECU) or are able to communicate with each other using the vehicle interface 45. The vehicle interface 45, for example, may include a controller area network (CAN) bus for communication between main modules and/or lower data rate communication such as local interconnect network (LIN) for communication between the sensors 31. The vehicle interface 45 can also include a clock extension peripheral interface (CXPI) bus. Additionally or alternatively, the vehicle interface 45 can include a combination of CAN bus, LIN, and CXPI bus communication interfaces. The structure of the sensors 31 are discussed in further detail below with reference to FIG. 3.

The control module 20 can include, for example, the communication gateway 29 that includes a BLE chipset 21 connected to an antenna 19. As shown in FIG. 2, the antenna 19 may be located in the vehicle 30. Alternatively, the antenna 19 may be located outside of the vehicle 30 or within the control module 20. The control module 20 can also include a link authentication module 22 that authenticates a user device 10 for communication via a communication link 50. The control module 20 can also include a data management layer 23 for push data. The control module 20 can also include a connection information distribution module 24. The control module 20 can also include a timing control module 25. The control module 20 can also include a telematics module 26, such as a global positioning system (GPS) module and/or other navigation or location modules. The control module 20 can also include a PEPS module 27. The control module 20 can also include a body control module 28. The control module 20 can also include a sensor processing and localization module 32. The control module 20 can also include a security filtering module 33.

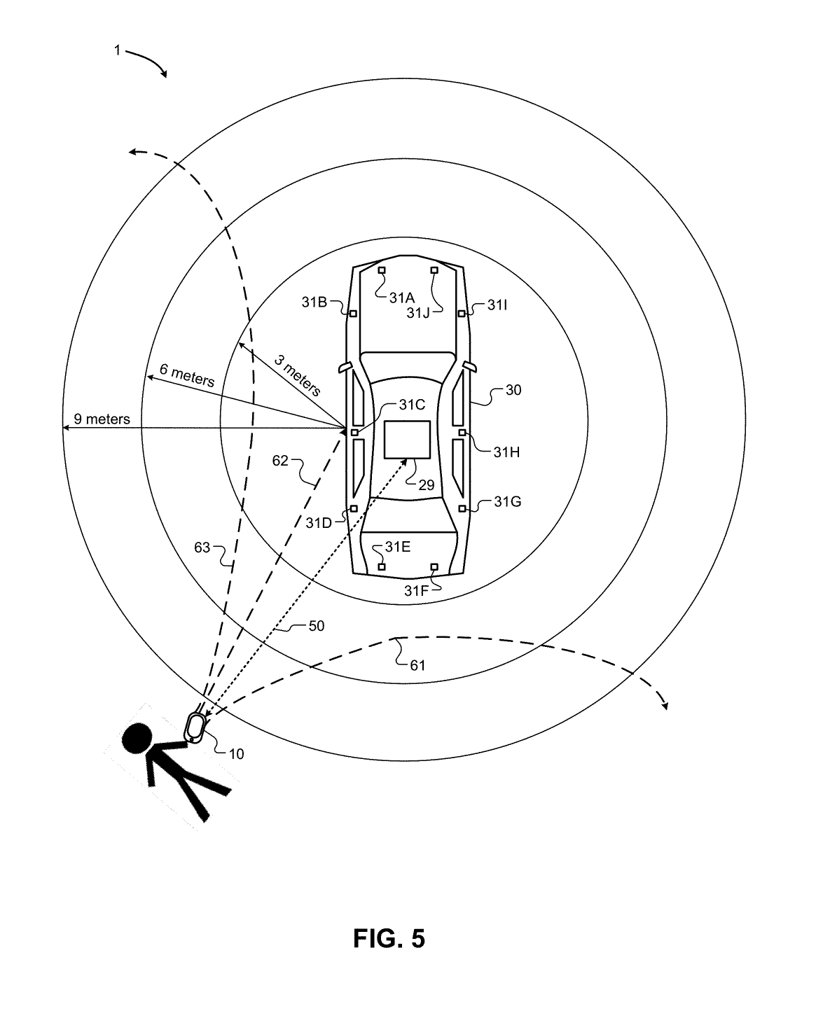

The control module 20 can also include a reference data generator module 34, a measurement timer 35, and an activation timer 36, each of which are described below in further detail with reference to FIGS. 5-8. The control module 20 may also include one or more processors that are configured to execute instructions stored in a nontransitory memory, such as a read-only memory (ROM) and/or random access memory (RAM).

As shown in FIGS. 1 and 2, the user device 10 can communicate with the communication gateway 29 of the vehicle 30 via the communication link 50. Without limitation, the user device 10 may be any Bluetooth enabled communication device, such as a smart phone, smart watch, wearable electronic device, key fob, tablet device, or other device associated with a user of the vehicle 30, such as an owner, driver, passenger of the vehicle 30, and/or a technician for the vehicle 30. As noted above, other wireless communication protocols could be used in place of Bluetooth or BLE, such as Wi-Fi, Wi-Fi direct, UWB, and/or IR USB. The user device 10 can include a BLE chipset 11 connected to an antenna 13. The user device 10 can also include application software 12 stored in a computer-readable storage module or device, such as a read-only memory (ROM) or a random-access memory (RAM). Further, the application software 12 includes instructions that are executable by a processor of the user device 10. The user device 10 can also include a GPS module 14 or other device location service.

The user device 10 and the communication gateway 29 can establish the communication link 50 using a Bluetooth communication link, as provided for and defined by the Bluetooth specification. For example, the communication link 50 between the user device 10 and the communication gateway 29 can be a BLE communication link. Alternatively, as noted above, a Wi-Fi, Wi-Fi direct, UWB, and/or IR UWB communication link may be used in place of the BLE communication link.

The PEPS system 1 may be configured to provide additional authentication of the communication link 50 with the user device. For example, the communication gateway 29 can communicate with the link authentication module 22 to authenticate the user device 10 and establish the communication link 50. For example, the link authentication module 22 can be configured to implement challenge-response authentication. In such case, timing information about the communication between the communication gateway 29 and the user device 10 is sent to the timing control module 25, which communicates with the sensors 31 through the vehicle interface 45, as described below. Further, the communication gateway 29 can communicate information about communication channels and channel switching parameters to the connection information distribution module 24. The connection information distribution module 24 is configured to communicate with each of the sensors 31 using the vehicle interface 45 and to provide the sensors 31 with communication information necessary for the sensors 31 to find and then follow the communication link 50 once the sensors 31 are synchronized with the communication gateway 29.

While FIGS. 1 and 2 illustrate a PEPS system 1 with ten sensors 31A-31J, any number of sensors can be used. For example, the PEPS system can include seven, eight, nine, eleven, twelve, or more sensors. In this way, while the present disclosure provides an example utilizing ten sensors, additional or fewer sensors can be used in accordance with the present disclosure.

With reference to FIG. 3, each of the sensors 31 includes a BLE chipset 41 connected to an antenna 43. As shown in FIG. 3, the antenna 43 may be located internal to the sensors 31. Alternatively, the antenna 43 may be located external to the sensors 31. The sensors 31 receive BLE Signals using the antenna 43 and, specifically, receive BLE physical layer messages using a BLE physical layer (PHY) controller 46. The sensors 31 are capable of observing BLE physical layer messages and taking measurements of the physical properties of the associated signals, including, for example, the received signal strength (RSSI) using a channel map that is produced by a channel map reconstruction module 42. Additionally or alternatively, the sensors 31 can determine other measurements of the physical properties of the associated signals, including, for example, data related to the angle of arrival. Additionally or alternatively, the sensors 31 can communicate with each other and/or communicate with the communication gateway 29 via the vehicle interface 45 to determine time difference of arrival, time of arrival, or angle of arrival data for signals received by multiple sensors. Additionally or alternatively, the sensors 31 can measure and determine round trip time of flight information about signals sent and received to and from the user device 10. The sensors 31 receive timing information and channel map information from the communication gateway 29 via the vehicle interface 45. A timing synchronization module 44 is configured to accurately measure the reception times of messages on the vehicle interface 45 and pass the timing information to the BLE chipset 41. The BLE chipset 41 is configured to take the channel map information and the timing signals and to tune the PHY controller 46 to a specific channel at a specific time and observe all physical layer messages and data that conform to the Bluetooth physical layer specification, which includes the normal data rates proposed or adopted, for example, in the Bluetooth Specification version 5.0. The data, timestamps and measured signal strength are reported by the BLE chipset 41 to the communication gateway 29 and/or control module 20 via the vehicle interface 45.

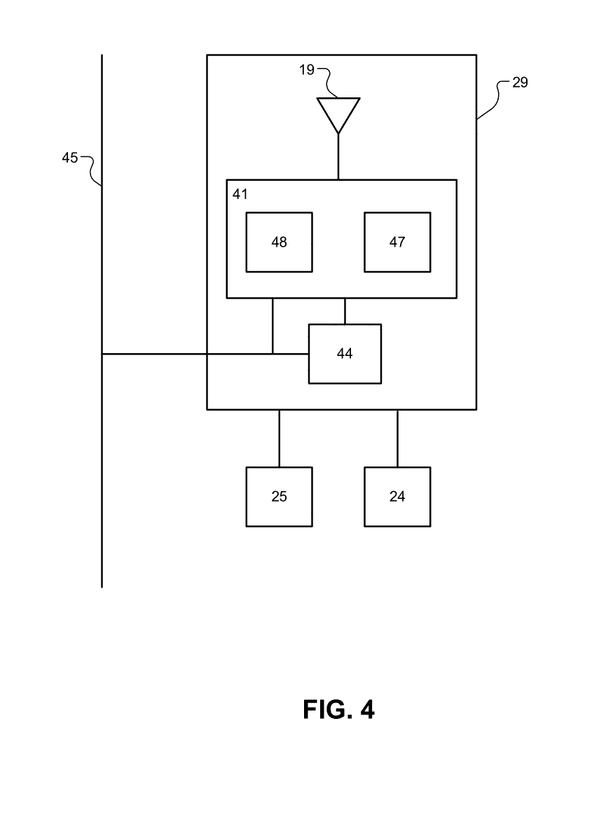

With reference to FIG. 4, the communication gateway 29 includes a BLE chipset 41 connected to an antenna 19 to receive BLE Signals. The BLE chipset 41 implements a Bluetooth protocol stack 48 that is, for example, compliant with the BLE specification, including, for example, version 5 of the BLE specification. The BLE chipset 41 also includes an application 47 implemented by application code stored in a computer-readable medium, such as a read-only memory (ROM) or a random-access memory (RAM). Further, the application 47 includes instructions that are executable by a processor of the BLE chipset 41. The application 47 may include modifications outside of the Bluetooth specification to enable the BLE chipset 41 to inspect timestamped data transmitted and received by the BLE chipset 41, regardless of the validity of the data. For example, the application 47 enables the BLE chipset 41 to compare transmitted and received data against expectations. The communication gateway 29 is configured to transmit the actual transmitted and received data to the control module 20 of the vehicle 30 via the vehicle interface 45. Alternatively, the communication gateway 29 can be configured to receive the data from each of the sensors 31 via the vehicle interface 45. The application 47 can be further configured to enable the BLE chipset 41 to confirm that each of the sensors 31 has received the correct data at the correct time.

With continued reference to FIG. 4, the communication gateway 29 is further configured to provide information about ongoing connections and timing signals necessary for each of the sensors 31 to find the connection being maintained by the communication gateway 29 with the user device 10, for example, and to subsequently follow the connection. The Bluetooth protocol stack 48 is configured to provide the channel map, access identifier, next channel, and the time to the next channel to the application 47. The Bluetooth protocol stack 48 is configured to output timing signals for the timestamps of transmission and reception events to the application 47 and/or a digital PIN output of the BLE chipset 41. The communication gateway 29 also includes a timing synchronization module 44. The timing synchronization module 44 is configured to accept the timing signals and works in conjunction with the vehicle interface 45 to create accurate time stamps of connection information messages and other communications.

With reference to FIG. 5, the PEPS system 1 is provided within the vehicle 30 and includes the communication gateway 29 and the sensors 31. As described above, the sensors 31 are configured to take measurements of the physical properties of the BLE signal transmitted by the user device 10 to the communication gateway 29 via the communication link 50. The sensors 31 may measure, for example, the RSSI of the BLE signal and data related to the angle of arrival of the communication link 50. Additionally, the sensors 31 may be configured to determine the time difference of arrival, time of arrival, angle of arrival, and/or round trip time of flight data of the BLE signal. Using the physical properties and/or data of the BLE signal, the communication gateway 29 and/or control module 20 may then determine a distance between the user device 10 and the vehicle 30.

As an example, in response to the communication gateway 29 being connected to the user device 10 via the communication link 50, the communication gateway 29 may provide the sensors 31 data corresponding to the BLE signal transmitted by the user device 10. In response to the data corresponding to the BLE signal provided by the communication gateway 29 matching the data corresponding to a BLE signal acquired by the sensors 31 from the user device 10 (e.g., a BLE communication packet received by the sensors 31 from the communication gateway 29 matches the BLE communication packet received by the sensors 31 from the user device 10), the sensors 31 are configured to generate RSSI measurements of the BLE signal.

As a specific example, if the user of the user device 10 walks along path 61, sensor 31E and sensor 31F may generate RSSI measurements having a first value, and sensor 31D and sensor 31G may generate RSSI measurements having a second value. Furthermore, if the user of the user device 10 walks along path 61, sensor 31C and sensor 31H may generate RSSI measurements having a third value, sensor 31B and sensor 31I may generate RSSI measurements having a fourth value, and sensor 31A and sensor 31J may generate RSSI measurements having a fifth value.

As another example, if the user of the user device 10 walks along path 62 and enters the vehicle 30, sensor 31C may generate a RSSI measurement having a sixth value, sensor 31D and sensor 31B may generate RSSI measurements having a seventh value, and sensor 31A and sensor 31E may generate RSSI measurements having an eighth value. Likewise, if the user of the user device 10 walks along path 63, sensor 31C, sensor 31B, and sensor 31D may generate RSSI measurements having a ninth value, sensor 31A and sensor 31F may generate RSSI measurements having a tenth value, etc.

The sensors 31 may provide the RSSI measurements to the control module 20. In response to the control module 20 receiving the RSSI measurements from the sensors 31, the control module 20 may determine the location of the user device 10, the distance between the user device 10 and the vehicle 30, and/or trajectory of the user device 10 based on the RSSI measurements received from the sensors 31. As an example, the control module 20 may determine that the user of the user device 10 traveled on path 61 based on the first value, second value, third value, fourth value, and/or fifth value, as described above. As another example, the control module 20 may determine that the user of the user device 10 traveled along path 62 based on the sixth value, seventh value, and/or eighth value, as described above. In other embodiments, the communication gateway 29 may receive the RSSI measurements from the sensors 31 and determine the location of the user device 10, the distance between the user device 10 and the vehicle 30, and/or trajectory of the user device 10 based on the RSSI measurements received from the sensors 31.

While the above embodiment describes the control module 20 being configured to determine the location of the user device 10 based on the RSSI measurements of the sensors 31, the control module 20 may also obtain GPS information corresponding to the location of the user device 10 via the communication gateway 29. As an example, the control module 20 may obtain GPS information from the user device 10 if the user device 10 is connected to the communication gateway 29 via the communication link 50. Additionally, the GPS information may also include user-specific information that further defines and/or identifies the GPS information. As an example, the GPS information may be tagged with user-specific information that identifies the GPS information as being associated with a particular location, such as a home of the user, a place of employment of the user, and a diner that the user frequently visits. This user-specific information may be obtained from a mapping application of the user device 10, such as the GOOGLE® Maps application.

In response to the control module 20 determining the location of the user device 10, the reference data generator module 34 may then generate an entry based on the determined location and store the entry in the reference database. The reference database, which is stored in a reference data store of the control module 20, may include a plurality of entries corresponding to the various measurements by the sensors 31. As an example, the reference data generator module 34 may generate an entry based on the RSSI measurements associated with path 61 and store it in the reference data store. Likewise, the reference data generator module 34 may generate entries corresponding to walking path 62 and path 63.

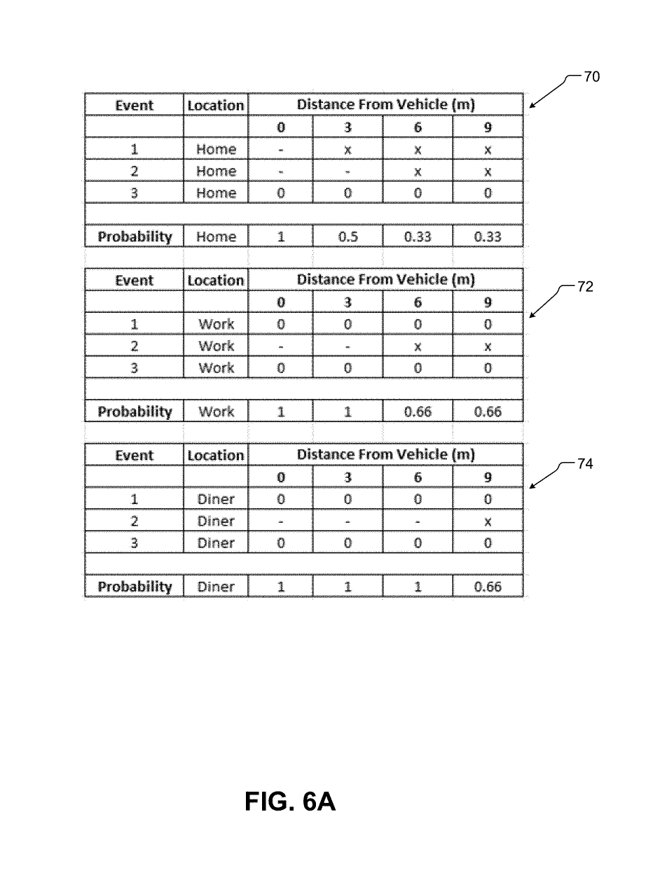

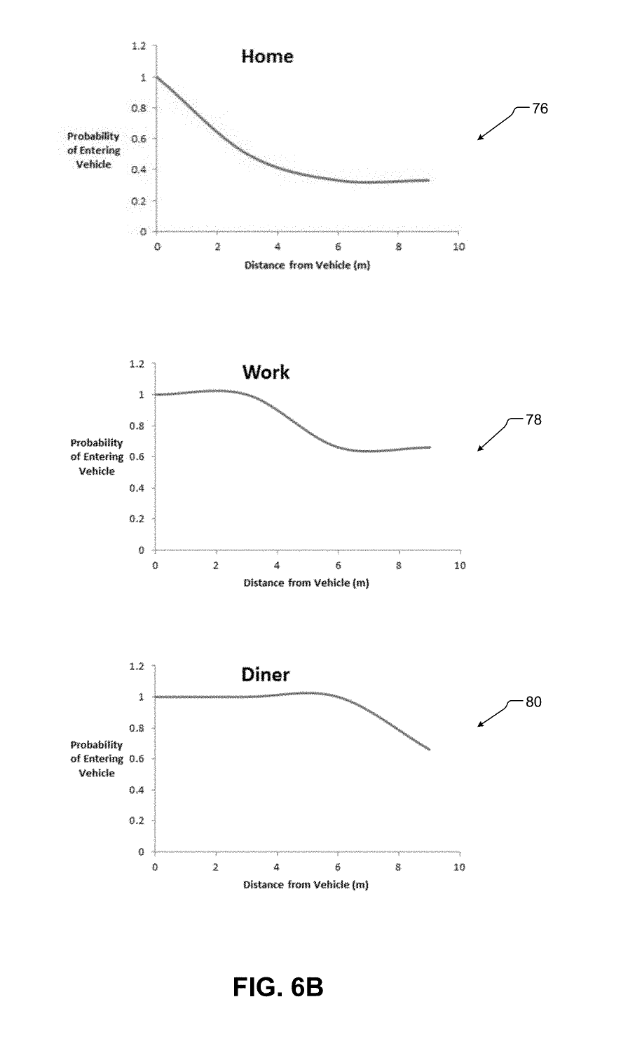

The entries may include information representing whether the user device 10 was located within predefined distance thresholds. As shown in FIG. 5, the predefined distance thresholds may be 3 meters, 6 meters, and 9 meters. Accordingly, the entry corresponding to path 61 may include information indicating that the user device 10 was detected within the 9 meter threshold and the 6 meter threshold. Furthermore, the entry corresponding to path 62 and path 63 may include information indicating that the user device 10 was detected within the 9 meter threshold, the 6 meter threshold, and the 3 meter threshold. The entries generated by the reference data generator module 34 are described below in further detail with reference to FIG. 6A.

Additionally or alternatively, the entries generated by the reference data generator module 34 may be adjusted and/or include information corresponding to whether the user entered the vehicle 30. As an example, the user of the user device 10 does not enter the vehicle when the user walks along path 61 and path 63. As such, the entries corresponding to path 61 and path 63 may include information and/or be adjusted to indicate that the user of the user device 10 did not enter the vehicle 30. As another example, the user of the user device 10 may enter the vehicle when the user walks along path 62. In order to detect whether the user enters the vehicle 30, a door of the vehicle 30 may include a sensor that is configured to detect and communicate an entry into the vehicle 30 to the control module 20. As such, the entry corresponding to path 62 may include information and/or be adjusted to indicate that the user of the user device 10 entered the vehicle 30.

As the reference data generator module 34 generates more entries, the control module 20 is able to more accurately determine whether the user of the user device 10 intends to enter the vehicle 30. As an example, the reference data generator module 34 may be configured to generate dynamic probability values that represent the probability that the user of the user device 10 will enter the vehicle 30. Furthermore, the reference data generator module 34 may generate a probability curve based on the dynamic probability values. The control module 20 may then compare RSSI measurements obtained by the sensors 31 to the probability curve in order to determine whether to make certain vehicle functions available to the user. The dynamic probability values, probability curve, and the activation of vehicle functions are described below in further detail with reference to FIG. 6B.

With reference to FIGS. 6A and 6B, various entries of the reference database are represented in table 70, table 72, and table 74. In table 70, three entries associated with a home location of the user device 10 are shown. Moreover, table 70 represents the entries associated with path 61, path 62, and path 63 in FIG. 5. In table 72, three entries associated with a work location of the user device 10 are shown. In table 74, three entries associated with a diner location are represented.

In the tables, a value represented by a “-” character indicates that no measurement was obtained at the corresponding distance threshold for that entry. A value represented by an “x” character indicates that a measurement was obtained at the corresponding distance threshold for that entry, but the user did not open the door and enter the vehicle 30. A value represented by a “0” character indicates that a measurement was obtained at the corresponding distance threshold for that entry and the user entered the vehicle 30.

As shown in table 70, the first entry (event 1) represents the measurements obtained by the sensor in response to the user of the user device 10 traveling on path 63. The first entry indicates that the user device 10 was detected using at least one of the sensors 31 at each of the 3 meter threshold, the 6 meter threshold, and the 9 meter threshold. Additionally, as shown in FIG. 5 and in table 70, the user of the user device 10 did not enter the vehicle 30.

The second entry (event 2) represents the measurements obtained by the sensors 31 in response to the user of the user device 10 traveling on path 61. The second entry indicates that the user device 10 was detected using the sensors 31 at the 6 meter threshold and the 9 meter threshold. Additionally, as shown in FIG. 5 and in table 70, the user device 10 was not detected using the sensors 31 at the 3 meter threshold, and the user of the user device 10 did not enter the vehicle 30.

The third entry (event 3) represents the measurements obtained by the sensors 31 in response to the user of the user device 10 traveling on path 62. The first entry indicates that the user device 10 was detected using the sensors 31 at each of the 3 meter threshold, the 6 meter threshold, and the 9 meter threshold, and that the user of the user device 10 entered the vehicle 30.

Table 72 and table 74 include similar entries, but represent entries for different locations, such as a place of employment of the user and a favorite diner of the user. Additionally or alternatively, the reference data generator module 34 may generate different tables for the same location and different times of the day. As an example, the reference data generator module 34 may include three tables for the home location, with a first table corresponding to home entries in the morning, a second table corresponding to home entries in the afternoon, and a third table corresponding to home entries in the evening.

The table 70 may also include dynamic probability values that are configured to update in response to receiving new entries. The dynamic probability values represent the probability that the user of the user device 10 will enter the vehicle 30 based on the reference database. As an example, the dynamic probability value of the home location of the user when the user is 0 meters away from the vehicle 30 (i.e., the user is in the vehicle 30) is 1; the dynamic probability value of the home location of the user when the user is 3 meters away from the vehicle 30 is 0.5; the dynamic probability value of the home location of the user when the user is 6 meters away from the vehicle 30 is 0.33; and the dynamic probability value of the home location of the user when the user is 9 meters away from the vehicle 30 is 0.33. As more entries are added to the table 70, each of the dynamic probability values continuously update based on the new entries. Accordingly, as more entries are added to the table 70, the control module 20 is able to more accurately determine the probability of the user of the user device 10 entering the vehicle 30.

As shown in FIG. 6B, the dynamic probability values can be represented by probability curves 76, 78, and 80. Probability curve 76 is associated with table 70; probability curve 78 is associated with table 72; and probability curve 80 is associated with table 74. While the probability curves 76, 78, and 80 are represented as continuous curves, in alternative embodiments, the probability curves 76, 78, and 80 may be represented as discontinuous curves.

Using the probability curves 76, 78, and 80, the activation of various vehicle functions may be assigned to different points along each of the probability curves 76, 78, and 80. As an example, the lighting system of the vehicle 30 may be activated at a home location of the user device 10 if the dynamic probability is at least 0.4. Accordingly, using probability curve 76, the control module 20 will activate the lighting system of the vehicle 30 at the home location if the user device 10 is within approximately 4 meters of the vehicle 30.

As another example, the door of the vehicle 30 may be unlocked at the home location of the user device 10 if the dynamic probability is at least 0.6. Accordingly, using probability curve 76, the control module 20 will unlock the door of the vehicle 30 at the home location if the user device 10 is within approximately 2 meters of the vehicle 30.

In other embodiments, similar dynamic probability values may be assigned to any other vehicle function, such as unlocking a trunk of the vehicle 30, starting the vehicle 30, activating a heating system of the vehicle 30, and activating an air conditioning system of the vehicle 30. Moreover, different dynamic probability values may be assigned to vehicle functions based on the location and/or time of day, as indicated by the tables of the reference database.

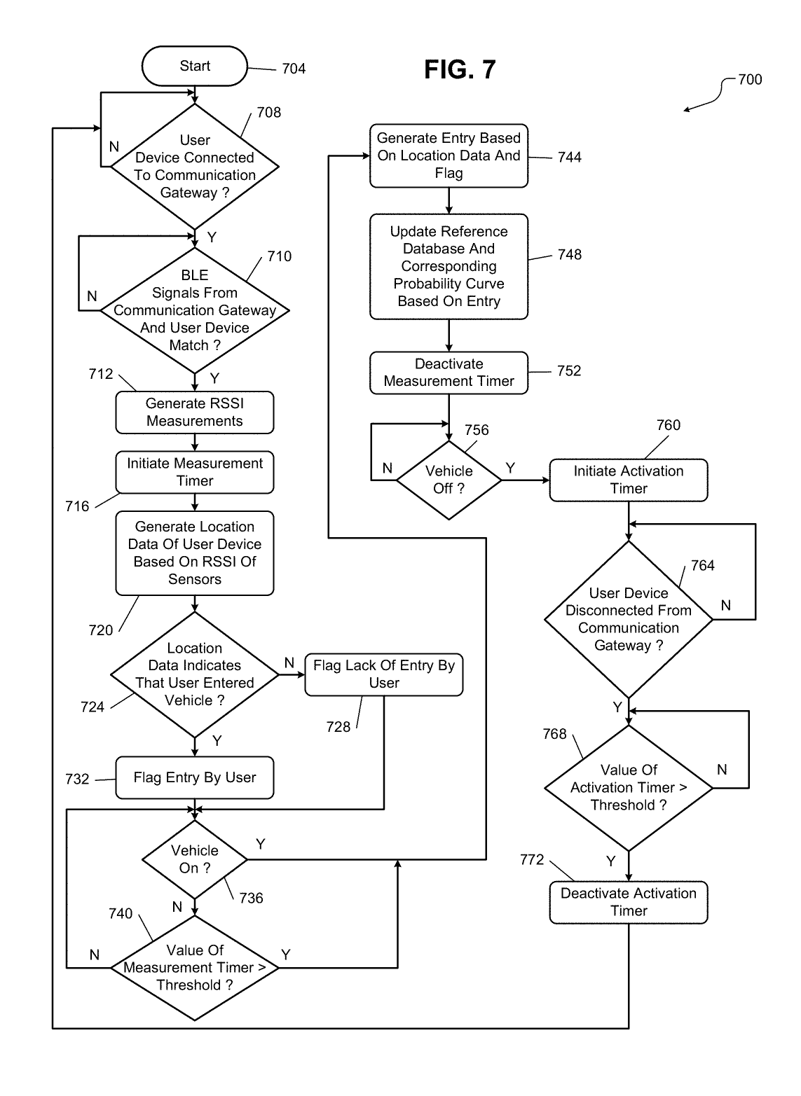

With reference to FIG. 7, a flowchart of an example control algorithm 700 for generating reference data and a corresponding probability curve is shown. The control algorithm 700 begins at 704 when, for example, the user turns on the user device 10. At 708, the control algorithm 700 determines, using the control module 20, whether the user device 10 is connected to the communication gateway 29 via the communication link 50. If so, the control algorithm 700 proceeds to 710; otherwise, the control algorithm 700 remains at 708 until the user device 10 is connected to the communication gateway 29. At 710, the control algorithm 700 determines whether the BLE signal received by the sensors 31 from the communication gateway 29 matches the BLE signal received by the sensors 31 from the user device 10. If so, the control algorithm 700 proceeds to 712; otherwise, the control algorithm 700 remains at 710 until the BLE signal received by the sensors 31 from the communication gateway 29 matches the BLE signal received by the sensors 31 from the user device 10.

At 712, the control algorithm 700 generates, using the sensors 31, RSSI measurements based on the BLE signal. At 716, the control algorithm 700 initiates the measurement timer 35, which is configured to instruct the control module 20 to generate location data as long as the value of the timer is less than a threshold value and the vehicle 30 remains off. At 720, the control algorithm 700 generates, using the control module 20, location data of the user device 10 based on the RSSI of the sensors 31, as described above. Additionally, the control module 20 may obtain the GPS coordinates and/or user-specific location data of the user device 10 in order to tag the data received by the sensors 31 with additional location data, as described above.

At 724, the control algorithm 700 determines, using the control module 20, whether the location data indicates that the user of the user device 10 entered the vehicle. If so, the control algorithm 700 proceeds to 728; otherwise, the control algorithm 700 proceeds to 732. At 728, the control algorithm 700 flags the entry with information corresponding to the user not entering the vehicle and then proceeds to 736. At 732, the control algorithm 700 flags the entry with information corresponding to the user entering the vehicle and then proceeds to 736.

At 736, the control algorithm 700 determines whether the vehicle 30 is on. If so, the control algorithm proceeds to 744; otherwise, the control algorithm 700 proceeds to 740. At 740, the control algorithm 700 determines whether the value of the measurement timer is greater than a threshold time; if so, the control algorithm 700 proceeds to 744; otherwise, the control algorithm 700 proceeds to 736. At 744, the control algorithm 700 generates an entry based on the location data and the flag. At 748, the control algorithm 700 updates the reference database and the corresponding probability curves based on the entry. At 752, the control algorithm 700 deactivates the measurement timer 35 and discontinues generating location data.

At 756, the control algorithm 700 determines whether the vehicle 30 is off. If so, the control algorithm 700 proceeds to 760; otherwise, the control algorithm 700 remains at 756 until the vehicle 30 is turned off. At 760, the control algorithm 700 initiates the activation timer 36, which is configured to prevent the control module 20 from generating location data while the user is exiting the vehicle 30. At 764, the control algorithm 700 determines whether the user device 10 is disconnected from the communication gateway 29. If so, the control algorithm proceeds to 768; otherwise, the control algorithm 700 remains at 764 until the user device 10 is disconnected from the communication gateway 29. At 768, the control algorithm 700 determines whether the value of the activation timer is greater than a threshold value. If so, the control algorithm 700 proceeds to 772; otherwise, the control algorithm 700 remains at 768 until the value of the activation timer is greater than the threshold value. At 772, the control algorithm 700 deactivates the activation timer 36 and then proceeds to 708.

The control algorithm 700 is configured to continuously operate and acquire measurements for updating the reference database and corresponding probability curves. As such, the more times the control algorithm 700 is executed, the more accurately the probability curve will indicate the probability that the user of the user device 10 will enter the vehicle 30.

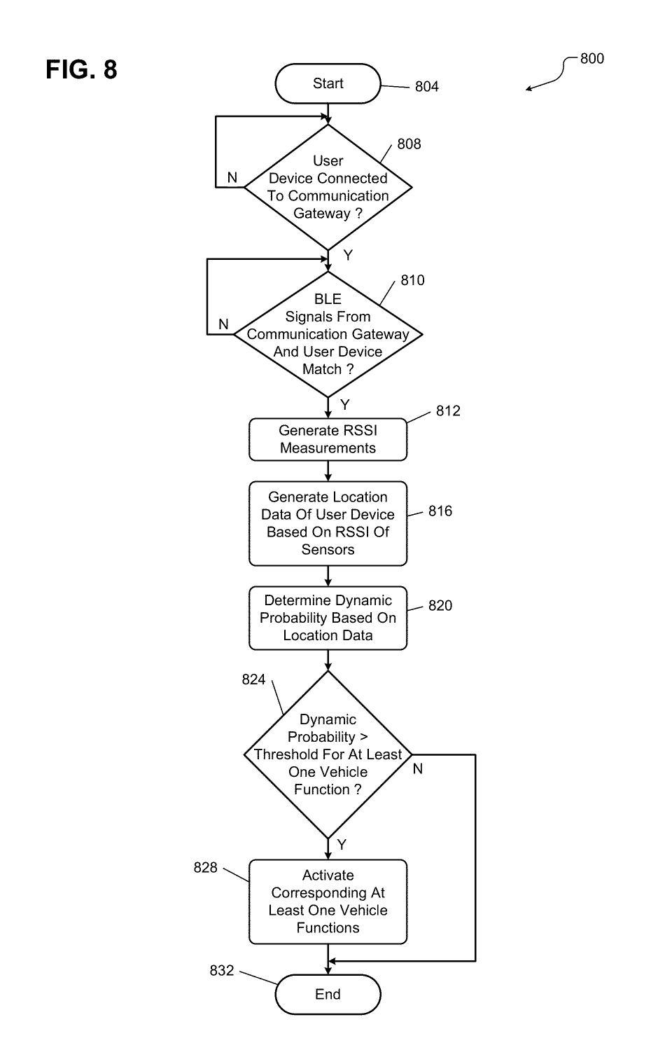

With reference to FIG. 8, a flowchart of an example control algorithm 800 for activating vehicle functions is shown. The control algorithm 800 may begin at 804 when, for example, the user turns on the user device. At 808, the control algorithm 800 determines, using the control module 20, whether the user device 10 is connected to the communication gateway 29 via the communication link 50. If so, the control algorithm 800 proceeds to 810; otherwise, the control algorithm remains at 808 until the user device 10 is connected to the communication gateway 29. At 810, the control algorithm 800 determines whether the BLE signal received by the sensors 31 from the communication gateway 29 matches the BLE signal received by the sensors 31 from the user device 10. If so, the control algorithm 800 proceeds to 812; otherwise, the control algorithm 800 remains at 810 until the BLE signal received by the sensors 31 from the communication gateway 29 matches the BLE signal received by the sensors 31 from the user device 10.

At 812, the control algorithm 800 generates, using the sensors 31, RSSI measurements based on the BLE signal. At 816, the control algorithm 800 generates, using the control module 20, location data of the user device 10 based on the RSSI of the sensors 31, as described above. Additionally, the control module 20 may obtain the GPS coordinates and/or user-specific location data of the user device 10 in order to tag the data received by the sensors 31 with additional location data, as described above. As described above, the sensor data may be tagged with location data in order to generate the reference data and the probability curves.

At 820, the control algorithm 800 determines the dynamic probability value based on the location data. At 824, the control algorithm 800 determines whether the dynamic probability is greater than a threshold dynamic probability for at least one of the vehicle functions, such as activating the lighting system of the vehicle 30. If so, the control algorithm 800 proceeds to 828; otherwise, the control algorithm 800 proceeds to 832. At 828, the control algorithm 800 activates the corresponding at least one vehicle function and proceeds to 832. At 832, the control algorithm 800 ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system comprising:
a communication gateway of a control module of a vehicle, wherein the communication gateway is configured to establish a wireless communication connection with a user device, the control module including at least one processor that is configured to execute instructions stored in a nontransitory memory;
a plurality of sensors that are configured to, in response to the user device being connected to the communication gateway, communicate signal information about the wireless communication connection to the control module;
a reference data generator module that is implemented by the at least one processor of the control module, wherein the reference data generator module is configured to determine a first probability value based on the signal information, and the first probability value indicates a probability that a user of the user device will enter the vehicle; and
a passive entry/passive start (PEPS) system that is configured to, in response to the first probability value being greater than at least one threshold probability, activate a vehicle function associated with the at least one threshold probability.

2. The system of claim 1, wherein the reference data generator module is configured to determine the first probability value is greater than the at least one threshold probability based on a probability curve, and the probability curve is generated by the reference data generator module and is based on at least one entry of a reference data store that is implemented by the nontransitory memory.

3. The system of claim 2, wherein the reference data generator module is configured to generate a first entry of the at least one entry, and the first entry is based on the signal information and corresponds to the first probability value.

4. The system of claim 3, wherein each of the at least one entry is associated with a measurement event and includes information indicating with whether the user of the user device enters the vehicle, signal information of the measurement event, and location data of the measurement event.

5. The system of claim 2, wherein the probability curve is based on at least one dynamic probability value, and the at least one dynamic probability value indicates the probability that the user of the user device will enter the vehicle when the user of the user device is within a threshold distance of the vehicle.

6. The system of claim 5, wherein the at least one dynamic probability value is configured to update in response to the reference data generator module generating a new entry of the at least one entry.

7. The system of claim 2, wherein the probability curve is a continuous curve.

8. The system of claim 1, wherein the vehicle function includes at least one of unlocking a door of the vehicle, unlocking a trunk of the vehicle, starting the vehicle, activating a heating system of the vehicle, activating an air conditioning system of the vehicle, and activating a lighting system of the vehicle.

9. The system of claim 1, wherein the wireless communication connection is a Bluetooth low energy (BLE) communication connection.

10. The system of claim 1, wherein the signal information includes at least one of a signal strength, a time of arrival, a time difference of arrival, an angle of arrival, and a round trip time of flight of a two-way ranging communication signal between the set of the plurality of sensors and the user device.

11. A method comprising:
establishing, with a communication gateway of a control module in a vehicle, a wireless communication connection with a user device, wherein the control module includes at least one processor that is configured to execute instructions stored in a nontransitory memory;
communicating, in response to establishing the wireless communication connection, signal information about the wireless communication connection from a plurality of sensors to the control module;
determining, using a reference data generator module that is implemented by the at least one processor of the control module, a first probability value based on the signal information, wherein the first probability value indicates a probability that a user of the user device will enter the vehicle; and
in response to the first probability value being greater than at least one threshold probability, activating, using a passive entry/passive start (PEPS) system, a vehicle function associated with the at least one threshold probability.

12. The method of claim 11, wherein determining the first probability value is greater than the at least one threshold probability is based on a probability curve, and the probability curve is generated by the reference data generator module and is based on at least one entry of a reference data store that is implemented by the nontransitory memory.

13. The method of claim 12, further comprising generating a first entry of the at least one entry, wherein the first entry is based on the signal information and corresponds to the first probability value.

14. The method of claim 13, wherein each of the at least one entry is associated with a measurement event and includes information indicating with whether the user of the user device enters the vehicle, signal information of the measurement event, and location data of the measurement event.

15. The method of claim 12, wherein the probability curve is based on at least one dynamic probability value, wherein the at least one dynamic probability value indicates the probability that the user of the user device will enter the vehicle when the user of the user device is within a threshold distance of the vehicle.

16. The method of claim 15, further comprising updating the at least one dynamic probability value in response to the reference data generator module generating a new entry of the at least one entry.

17. The method of claim 12, wherein the probability curve is a continuous curve.

18. The method of claim 11, wherein the activating the vehicle function includes at least one of unlocking a door of the vehicle, unlocking a trunk of the vehicle, starting the vehicle, activating a heating system of the vehicle, activating an air conditioning system of the vehicle, and activating a lighting system of the vehicle.

19. The method of claim 11, wherein the wireless communication connection is a Bluetooth low energy (BLW) communication connection.

20. The method of claim 11, wherein the signal information further includes at least one of a signal strength, a time of arrival, a time difference of arrival, an angle of arrival, and a round trip time of flight of a two-way ranging communication signal between the set of the plurality of sensors and the user device.
